(19) United States
(12) Patent Application Publication
(10) Pub. No.: US 2016/0231438 A1
(43) Pub. Date: Aug. 11, 2016

(54) SYSTEM FOR MEASURING RADIOACTIVITY IN A GAMMA BACKGROUND NOISE

(71) Applicant: COMMISSARIAT A L'ENERGIE ATOMIQUE ET AUX ENERGIES ALTERNATIVES, Paris (FR)

(72) Inventors: Romain Coulon, Chaulgnes (FR); Thierry Montagu, Paris (FR); Vincent Schoepf, Antony (FR); Stephane Normand, Isigny Le Buat (FR)

(21) Appl. No.: 15/025,646

(22) PCT Filed: Sep. 25, 2014
(86) PCT No.: PCT/EP2014/070457

§ 371 Date: Mar. 29, 2016

(30) Foreign Application Priority Data
Oct. 1, 2013 (FR) 1359513

(51) Int. Cl. G01T 1/178; G01T 1/20; G01T 1/185; G01T 1/24

(52) U.S. Cl. CPC G01T 1/178; G01T 1/24; G01T 1/2018; G01T 1/185

(57) ABSTRACT

A method and a device for compensation-based measurement of the alpha and/or beta radioactivity in a gamma background noise comprising a compensation probe comprises a first sensor allowing the measurement of the alpha and/or beta and gamma radioactivity and a second sensor not allowing the measurement of the alpha and/or beta radioactivity but allowing the measurement of the gamma radioactivity; wherein the sensors are arranged to be exposed substantially to the same gamma background noise; measurement biases being associated with the geometric arrangement of the sensors on account of the anisotropy of the gamma radiation; the measurement system determines the alpha and/or beta radioactivity by compensation comprising a subtraction between the measurement of alpha and/or beta and gamma radioactivity and the gamma measurement, the compensation minimizing the measurement biases associated with the geometric arrangement of the sensors. Other developments are described to improve the reliability of the radioactivity measurements.

### FIELD OF THE INVENTION

The invention relates to the measurement of radioactivity and more particularly the measurement of alpha (α) and beta (β) charged particles in a gamma (γ) background noise.

### STATE OF THE ART

Several categories of contamination measurement technologies exist. These measurement systems are commonly implemented in the guise of radioprotection toolkit for the detection and measurement of radioactive contamination (contaminometer).

Uncompensated measurements are the simplest and the least expensive. They implement detectors of large surface area (plastic or gaseous) with a very fine input surface (made of Mica or Mylar for example) and a sensitive volume optimized for the detection of particles of interest with respect to gamma radiation. The actual movement of the detector depends on the surrounding gamma background noise. This signal is ultimately very subjective and must be interpreted as a function of its location, requiring operator know-how and longer exposure.

Measurements using compensation schemes are known. These schemes implement a guard detector (shielded in relation to charged particles) so as to compensate the measurement pathway. These systems are aimed at being independent of the changes of intensity of the gamma background noise. In theory the net signal represents the signal of interest of the alpha and/or beta charged particles. In practice, however, these systems exhibit numerous false positives because of the dependency of these systems on the changes of spatial distribution of the gamma background noise. The operator changing the position of the sensors in space sometimes very substantially modifies the measured values.

So-called discrimination measurements correspond to another type of technology aimed at addressing this problematic issue posed by the anisotropy of the gamma background noise. A discrimination-based measurement system is generally composed of two detectors (or of a “phoswich”, that is to say a “sandwich” of detectors or sensors, known as a “telescope” in French) discriminating the charged particles by their continuous mode of interaction by comparison with gamma radiations and with their probabilistic mode of interaction. It is then necessary to implement electronics for coincidence processing or for Pulse Shape Discrimination (PSD). The net signal corresponds to the signal of the particles of interest. Stability may be guaranteed whatever the changes of intensity and of spatial distribution of the gamma background noise. This technology is more expensive than the examples of implementation of the invention.

In actual fact and at the present time, compensation measurements remain attractive because of their low implementation cost. Existing compensation solutions are preferred to discrimination schemes for reasons of implementational simplicity and optimization of production costs.

However, current compensation approaches exhibit metrological limitations which pose problems (detection of false positives) when deploying these technologies in the field in industry.

The invention is aimed at remedying the aforementioned drawbacks.

### SUMMARY OF THE INVENTION

In one embodiment there is provided a system for compensation-based measurement of the alpha and/or beta radioactivity in a gamma background noise comprising a base unit comprising a first sensor allowing the measurement of the alpha and/or beta and gamma radioactivity (a,b,g) and a second sensor not allowing the measurement of the alpha and/or beta radioactivity but allowing the measurement of the gamma radioactivity (g);

characterized in that the sensors are arranged so as to be exposed substantially to the same gamma background noise; measurement biases being associated with the geometric arrangement of the sensors on account of the anisotropy of the gamma radiation; and the measurement system determines the alpha and/or beta radioactivity (a,b) by compensation, said compensation comprising a subtraction between the measurement of alpha and/or beta and gamma radioactivity (a,b,g) and the gamma measurement (g) multiplied by a compensation parameter k, said compensation minimizing the measurement biases associated with the geometric arrangement of the sensors. This geometric arrangement can be effected in multiple ways (sensors glued one behind another for example, but other arrangements remain possible, such as sensors juxtaposed, side by side, slightly offset, etc.).

According to a development, the compensation parameter k as well as its associated properties such as its uncertainty sigma(k) are calculated on the basis of the distribution of this compensation parameter k.

According to a development, the distribution originates from a predefined experimental database or from a base of simulated data or by accumulation of data by the measurement system.

According to a development, a first confidence threshold is associated with the calculation of the compensation parameter k on the basis of the distribution of the compensation parameter k.

According to a development, a second statistical confidence threshold is associated with the discrete nature of the count values arising from the pulses detected by the sensors. This threshold is independent of the compensation parameter k.

According to a development, the first confidence threshold and the second confidence threshold are of the same level. Stated otherwise, the wrong-detection rate (or alpha risk in the statistical sense) is the same.

According to a development, the compensation parameter k is a mean compensation parameter k̅ or a unique and predefined compensation parameter. This implementation is the most direct but not necessarily the one that gives the best results.

According to a development, the measurement system comprises several n base units and the compensation takes into account the distribution of the compensation parameter as a function of the ratio of the signals of the plurality n of the base units and of the functional regression of the associated measurements in dimension n=2 (or of the matrix solution of the linear system with n dimensions if n>2). The plurality of sensors allows measurements which may be faster, more reliable sometimes. According to a development, a plurality of base units is carried by aquatic, terrestrial or aerial vehicles, driven automatically or teleguided. This optional implementation allows contaminated zone mapping applications, when the base units are mutually mobile.

According to a development, the sensor is a gas-type sensor and/or scintillation-type sensor and/or semiconductor-type sensor. Each type of sensor exhibits advantages and drawbacks. For example, a gas-type sensor generally presents an economic advantage, a scintillation-type sensor generally presents an advantage in regard to reproducibility of measurements, a semiconductor-type sensor exhibits different sensitivity ranges. Several sensors of different type can advantageously be combined (used jointly).

According to a development, a correction parameter for the sensitivity of a sensor is taken into account in the signal processing chain. This optional implementation improves the reliability and the precision of the measurements.

According to a development, the measurement system furthermore comprises an interface for display of the alpha and/or beta activity, which is displayed only if it is deemed significant in regard to thresholds relating to statistical fluctuations of the signal arising from the sensors and/or anisotropy biases of the gamma background radiation.

According to a development, the compensation parameter is calculated by an automatic learning (or “machine learning”) approach, that is to say one or more learning techniques employed in artificial intelligence (neural networks etc.).

According to a development, the radioactivity measurements and the compensation operations associated with these radioactivity measurements are decoupled in time and/or space. The compensation operations can be done in the laboratory afterwards for example, or the data being transmitted by wireless means, the computing equipment allocated to the compensation steps may be sited in non-irradiated zones.

Also disclosed is a method of compensation-based measurement of the alpha and/or beta radioactivity in a gamma background noise comprising a base unit comprising a first sensor allowing the measurement of the alpha and/or beta and gamma radioactivity (a,b,g) and a second sensor not allowing the measurement of the alpha and/or beta radioactivity but allowing the measurement of the gamma radioactivity (g); characterized in that the sensors are arranged so as to be exposed substantially to the same gamma background noise; measurement biases being associated with the geometric arrangement of the sensors on account of the anisotropy of the gamma radiation; and the measurement system determines the alpha and/or beta radioactivity (a,b) by compensation, said compensation comprising a subtraction between the measurement of alpha and/or beta and gamma radioactivity (a,b,g) and the gamma measurement (g) multiplied by a compensation parameter k, said compensation minimizing the measurement biases associated with the geometric arrangement of the sensors.

According to a development of the method, the compensation parameter k as well as its associated properties such as its uncertainty sigma(k) are calculated on the basis of the distribution of this compensation parameter k.

According to a development of the method, the distribution originates from a predefined experimental database or from a base of simulated data or by accumulation of data by the measurement system.

According to a development of the method, a first confidence threshold is associated with the calculation of the compensation parameter k on the basis of the distribution of the compensation parameter k.

According to a development of the method, a second statistical confidence threshold is associated with the discrete nature of the count values arising from the pulses detected by the sensors.

According to a development of the method, the first confidence threshold and the second confidence threshold are of the same level.

According to a development of the method, the compensation parameter k is a mean compensation parameter k̅ or a unique and predefined compensation parameter.

According to a development of the method, in the presence of several n base units, the compensation takes into account the distribution of the compensation parameter as a function of the ratio of the signals of the plurality n of the base units and of the functional regression of the associated measurements in dimension n=2 (or of the matrix solution of the linear system with n dimensions if n>2).

According to a development of the method, the sensor is a gas-type sensor and/or scintillation-type sensor and/or semiconductor-type sensor.

According to a development of the method, a correction parameter for the sensitivity of a sensor is taken into account in the signal processing chain.

According to a development of the method, the measurement system furthermore comprises an interface for display of the alpha and/or beta activity, which is displayed only if it is deemed significant in regard to thresholds relating to statistical fluctuations of the signal arising from the sensors and/or anisotropy biases of the gamma background radiation.

According to a development of the method, a plurality of base units is carried by aquatic, terrestrial or aerial vehicles, driven automatically or teleguided.

According to a development of the method, the compensation parameter is calculated by an automatic learning approach.

According to a development of the method, the radioactivity measurements and the compensation operations associated with these radioactivity measurements are decoupled in time and/or space.

Also described is a computer program product, said computer program comprising code instructions making it possible to perform the steps of the method when the program is executed on a computer.

The anisotropy biases are minimized by a design geometry and by a conservative detection threshold.

The anisotropy biases are minimized on account of the combination between on the other hand a) a particular arrangement or layout between two sensors of the same type (a sensor which measures alpha/beta and a sensor which does not measure alpha/beta, the two sensors being suitable for the measurement of the gamma radiation), this particular arrangement involving a residual geometric uncertainty and on the other hand b) a compensation aimed at minimizing this residual geometric uncertainty.

The expression “sensor of the same type” is understood to mean sensors of the same technology. By definition, two sensors are necessarily very slightly different (cannot be strictly identical). In practice, the sensors according to the invention correspond to identical or similar catalog references.

The sensors can be arranged or laid out in various ways. They are disposed in such a way as to be exposed to one and the same gamma flux (that is to say substantially the same). Being unable to be merged, these two sensors are in a configuration associated with a residual geometric layout uncertainty, that is to say which is unable to be known directly. The compensation operations will precisely minimize or diminish or indeed eliminate or annihilate this geometric bias of layout between the sensors.

The invention comprises electronic means of signal processing allowing the counting of the pulses detected by each sensor, these pulses being associated with the measurement of the alpha and/or beta radioactivity.

Advantageously, the examples described make it possible to render the compensation measurements metrologically more robust in relation to the anisotropy biases.

Advantageously, the examples described make it possible to improve the compensation of the pathways as the spatial distribution of the gamma background noise evolves, and therefore to actually manage the anisotropy of the gamma background noise.

Advantageously, the examples described afford an ergonomic gain in respect of the radioprotection instrument without increasing the hardware cost of the latter.

Still advantageously, the invention allows the operator to be more confident in his alpha and/or beta radioactivity measurement instrument, said operator no longer needing to reinterpret the measurement as a function of the location of the measurement and needing less experience to perform reliable measurements.

The invention will advantageously be implemented in situations of detection and measurement of the contamination of a surface by alpha and/or beta emitters during radioprotection interventions. For example, the system and the scheme will be used within the framework of radioprotection in fuel cycle plants, nuclear power stations, nuclear medicine units, of a post-accident or decommissioning intervention at nuclear sites. Reliable, low-cost contamination mapping is also rendered possible by the invention.

To obtain the sought-after results, a method, a device and a computer program product are proposed. The computer program product comprises code instructions makes it possible to perform the compensation operations when the program is executed on a computer.

Advantageously, the invention is implemented in a reconfigurable or programmable onboard system, amalgamating measurements and compensation of the measurements, for example in one and the same portable toolkit. Alternatively, measurements and compensation can be decoupled in time and/or space. For example, the measurements according to the kit of the invention can be performed, collected and stored initially; then the analysis and the compensation or compensations according to the invention can be performed later subsequently, or even somewhere else. This type of implementation will be useful in the case of mappings of zones, for safety applications. It is possible in certain cases to place the sensors or the base units on robots or drones or other types of automatically driven or teleguided vehicles.

### DESCRIPTION OF THE FIGURES

Various aspects and advantages of the invention will become apparent in support of the description of a preferred but nonlimiting mode of implementation of the invention, with reference to the figures hereinbelow:

FIG. 1 is a schematic of an exemplary embodiment of a detection system according to the invention;

FIG. 2 is a diagram of the measurement system;

FIG. 3 illustrates an exemplary distribution obtained by a contaminometer operating by compensation;

FIG. 4 shows a measurement system composed of several base units;

FIG. 5 presents an exemplary fit obtained by functional regression of the experimental data.

### DETAILED DESCRIPTION OF THE INVENTION

Radioactivity produces various types of ionizing radiations, especially alpha particles, beta particles, protons, neutrons and gamma rays. Alpha radiation (consisting of helium nuclei) is simply stopped by a sheet of paper. Beta radiation (consisting of electrons or positrons) is stopped by an aluminum plate. Gamma radiation (consisting of very energetic photons) is attenuated (and not halted) when it penetrates dense material, thereby rendering it particularly dangerous to living organisms. Gamma radiation is generally anisotropic. Anisotropy is the property of being dependent on direction. An anisotropic thing will be able to exhibit various characteristics according to its orientation. This gamma radiation influences the alpha and beta radioactivity measurement results. It is therefore appropriate to ascertain the gamma radiation in order to establish reliable measurements of alpha and/or beta radioactivity.

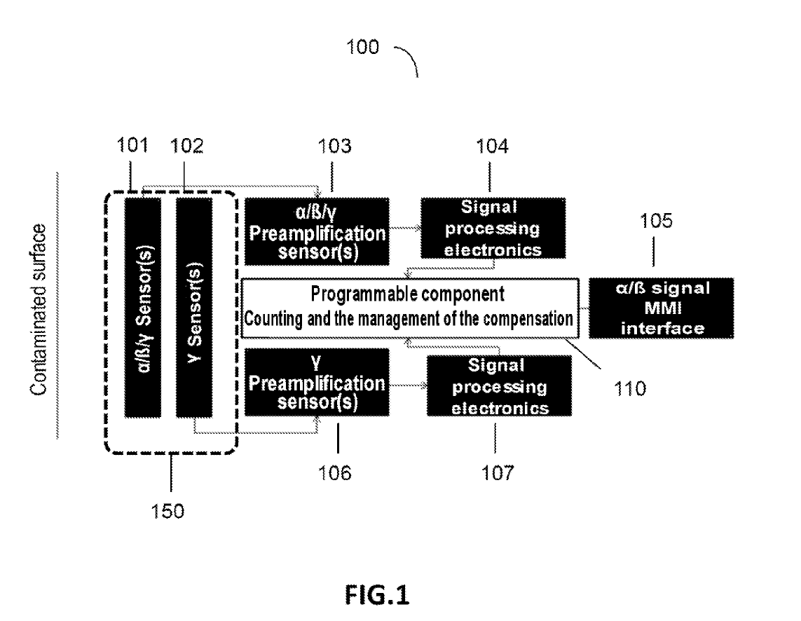

FIG. 1 presents by a schematic 100 an exemplary embodiment of a detection system according to the invention. In the description, the terms and expressions “sensors”, “guard detectors”, “guard detectors shielded in relation to charged particles”, “measurement pathway” and “compensation probe” are interchangeable.

A first sensor 101 measures the alpha, beta and gamma radioactivity. It therefore allows the counting of alpha and/or beta particles. The input window of the sensors can advantageously be as fine as possible (Mylar, Mica, etc.).

A second sensor 102 is sensitive only to gamma radiation alone. It does not measure alpha or beta radioactivity. The second sensor 102 is of the same type and approximately of the same sensitive volume as the first sensor 101 but, as indicated previously, does not detect alpha and/or beta particles.

The two sensors are amalgamated and arranged within a “base unit” 150. The two sensors are arranged so as to be exposed substantially to the same gamma background noise.

The signals arising from the sensors are pulses corresponding to the ionizing radiations. Each sensor is associated with a pre-amplification system 103, 106 intended to amplify the signals delivered at its output. A sensor 101, 102 and its associated preamplifier 103, 106 form a measurement pathway. The pathway comprising the second sensor measuring the gamma radiations may subsequently be called the guard pathway. An electronic module 104, 107 is connected at the output of each measurement pathway. It performs the amplification, the filtering of the pulses arising from the measurement pathway. A programmable component 110 carries out the counting of the pulses of each pathway and performs the compensation steps according to the invention. The expression “counting arising from the measurement pathway” therefore refers to “measurement”.

A display 105, on-board or off-board, returns the results, such as the alpha and beta radioactivity information sought, together with alerts and optionally other types of intermediate information such as the statistical fluctuations of the gamma radiation or indicators related to the anisotropy of the ambient gamma radiation or else yet other types of information (video communication, GPS information, photograph, alert system or the like). Various types of man-machine interface can be used (local screen, video off-board on a remote machine) and according to diverse cognitive modalities (augmented reality, interpretation via luminous and/or auditory signals, haptic feedback, etc.).

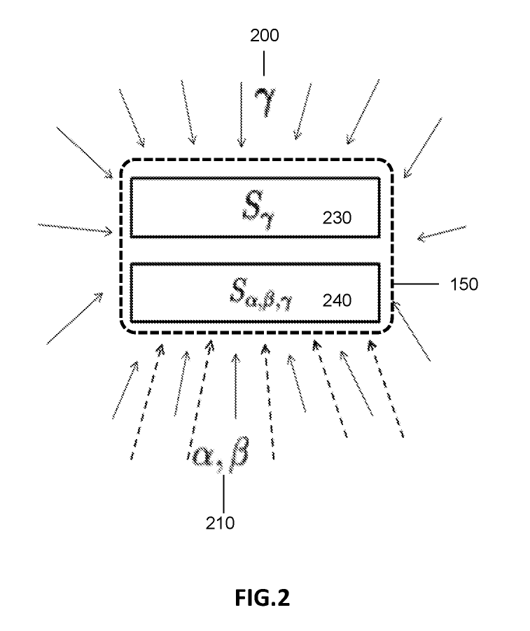

FIG. 2 presents via a diagram the principle of measurement at the level of the sensors. Let S_{α,β,γ} 240 be the measurement arising from the first sensor 101 measuring the alpha, beta, gamma radiations 210 and S_{γ} (230) the measurement arising from the second sensor 102 measuring only the gamma background noise 200. The counts (or measurements) 230 and 240 are performed by the sensors 101, 102 amalgamated within the base unit 150.

If the gamma background noise is perfectly isotropic then the signal of interest S_{α,β} giving the measurement of the α and/or β radioactivity is calculated according to equation 1:

S_{α,β}=S_{α,β,γ}−S_{γ} (Equation 1)

In practice, the gamma background noise 200 is not strictly isotropic. This is why the compensation measurements exhibit a metrological fragility, despite their independence in relation to the variations of the background noise intensity.

To improve the measurements, according to a first implementation of the invention, a compensation parameter k is added to the model in equation 2:

S_{α,β}=S_{α,β,γ}−kS_{γ} (Equation 2)

This constant compensates for the anisotropy effect for a particular measurement configuration, thereby exhibiting advantages from the outset. This weighted subtraction of the signals offers a first solution to the problems related to the anisotropy of the gamma radiation.

This constant k may no longer fulfill its role as soon as the measurement changes configuration (for example, when the orientation of the sensors changes in space, on account of a movement of the operator).

Accordingly, according to another implementation of the invention, a mean compensation parameter k is calculated by simulation—or empirically—on the basis of a contamination-free measurement database. With a series of N measurements:

$$\tilde{κ} = \frac{1}{N} {\sum }_{i = 1}^{N} \frac{{S}_{α , β , γ}}{{S}_{γ}} \qquad ( Equation 3 )$$

Thus equation 4 gives on average a less biased estimation of the signal of interest (alpha, beta) but the risk of false positives remains a residual problem.

S_{α,β}=S_{α,β,γ}−k̅S_{γ} (Equation 4)

To correct this risk of false positives, the compensation takes into account the distribution of the compensation parameter k.

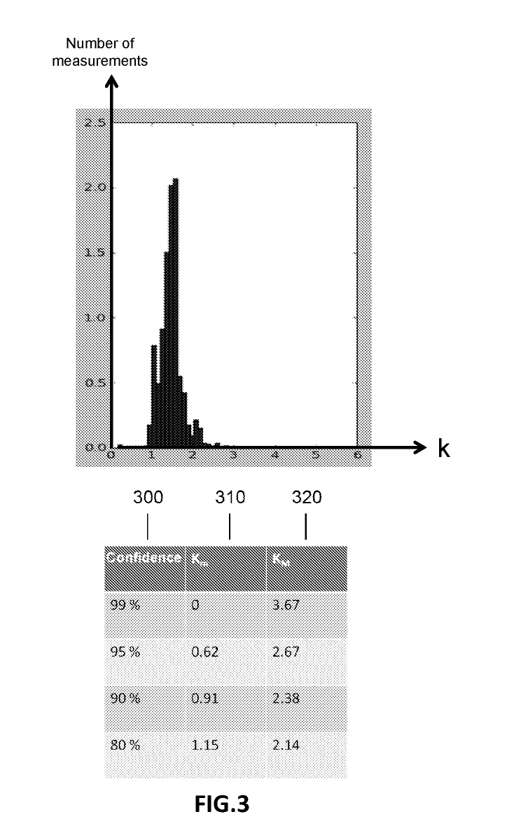

FIG. 3 illustrates an exemplary distribution of this compensation parameter. Plotted as abscissa is the observed value of the parameter k and plotted as ordinate is the number of measurement data corresponding to each value of k. The distribution is obtained by a contaminometer operating by compensation (“reference device”, “gauge device”, “golden prototype”). A distribution law for the parameter (Normal law, Student's law, etc.) is determined, and then fitted so as to be able to calculate the quantiles k_{M} 320 and kₘ 310 corresponding to the desired confidence level 300.

In the example of FIG. 3, the distribution has been fitted by a Student's law so as to best describe the reality that may be encountered in the field.

The uncertainty in the minimum and maximum quantiles of the distribution makes it possible to calculate two uncertainties associated with the compensation parameter.

u²(k̅₄)=(k_{M}−k̅)² and u²(k̅_{_})=(k̅−kₘ)²

Furthermore, u²(S_{α,β,γ}) and u²(S_{γ}) are the statistical uncertainties associated with the two measurement pathways. By considering a Poisson distribution of the counts as well as a broadening factor k (same confidence level as previously), the uncertainties in counts become:

u²(S_{α,β,γ})=k²S_{α,β,γ} and u²(S_{γ})=k²S_{γ}

Two detection bounds are then calculated by aggregating the stochastic and systematic uncertainties considered to be mutually independent:

$${u}_{+}^{2} ( {S}_{α , β} ) = {( \frac{\partial {S}_{α , β}}{\partial {S}_{α , β , γ}} )}^{2} {u}^{2} ( {S}_{α , β , γ} ) + {( \frac{\partial {S}_{α , β}}{\partial {S}_{γ}} )}^{2} {u}^{2} ( {S}_{γ} ) + ( \frac{\partial {S}_{α , β}}{\partial \overline{n}} ) {u}^{2} ( {\overline{κ}}_{+} )$$

$${u}_{+}^{2} ( {S}_{α , β} ) = {k}^{2} ( {S}_{α , β , γ} + {\overline{κ}}^{2} {S}_{γ} ) + {{S}_{γ}^{2} ( {κ}_{M} - \overline{κ} )}^{2}$$

$${u}_{-}^{2} ( {S}_{α , β} ) = {( \frac{\partial {S}_{α , β}}{\partial {S}_{α , β , γ}} )}^{2} {u}^{2} ( {S}_{α , β , γ} ) + {( \frac{\partial {S}_{α , β}}{\partial {S}_{γ}} )}^{2} {u}^{2} ( {S}_{γ} ) + {( \frac{\partial {S}_{α , β}}{\partial \overline{κ}} )}^{2} {u}^{2} ( {\overline{κ}}_{-} )$$

$${u}_{-}^{2} ( {S}_{α , β} ) = {k}^{2} ( {S}_{α , β , γ} + {\overline{κ}}^{2} {S}_{γ} ) + {{S}_{γ}^{2} ( \overline{k} - {κ}_{M} )}^{2}$$

The compensation steps according to the invention therefore become those defined hereinafter.

The parameters used are the following:

Mean compensation factor k̅

Maximum compensation factor k_{M}

Minimum compensation factor kₘ

Broadening factor k

In a first step, the reading of the counts of the alpha, beta, gamma pathway and of the gamma pathway is performed:

Reading S_{α,β,γ}

Reading S_{γ}

In a second step, the signal S_{α,β} is calculated

S_{α,β}=S_{α,β,γ}−k̅S_{γ}

In a third step, the detection bounds are calculated.

u₊²(S_{α,β})=k²(S_{α,β,γ}+k̅²S_{γ})+S_{γ}²(k_{M}−k̅)²

u₋²(S_{α,β})=k²(S_{α,β,γ}+k̅²S_{γ})+S_{γ}²(k̅−k_{M})²

In a following step, a detection test is performed in the following manner:
If S_{α,β}>u_{″}²(S_{α,β}) and S_{α,β}>u₊²(S_{α,β}) then S_{α,β}=S_{α,β}
Else S_{α,β}=0

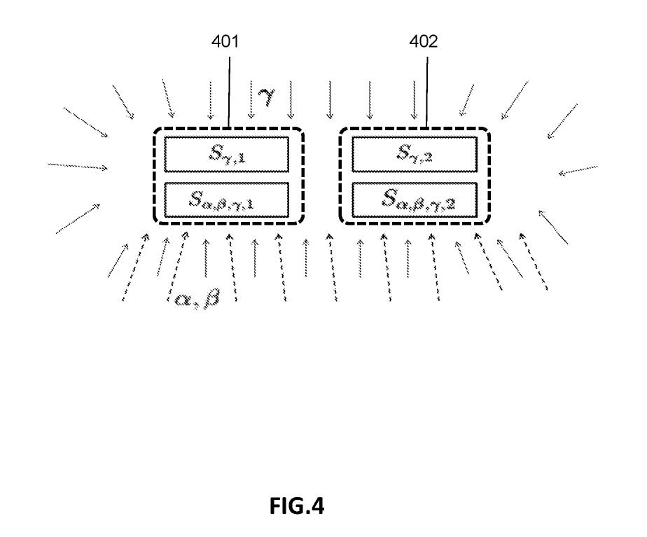

FIG. 4 shows a measurement system composed of several base units 401 and 402. In the case where the system is composed of several base units it is possible to improve the detection sensitivity by injecting a priori information on the distribution in background noise.

Let S_{α,β,γ,1} and S_{α,β,γ,2} be the counts arising from the alpha, beta, gamma measurement pathways and S_{γ,1} and S_{γ,2} the counts arising from the gamma guard pathways.

Two mean-compensation parameters k̅₁ and k̅₂ are calculated by simulation or empirically on the basis of a contamination-free measurement database. Initially the ratios S_{α,β,γ,1}/S_{γ,1} and S_{α,β,γ,2}/S_{γ,2} are distributed as a function of the ratio of the guard pathways carrying the information regarding the spatial distribution of the gamma flux S_{γ,1}/S_{γ,2}. A function is thereafter fitted in such a way as to best pass through the set of these points and by taking a law hypothesis in accord with the data obtained (typically Normal law or Student law).

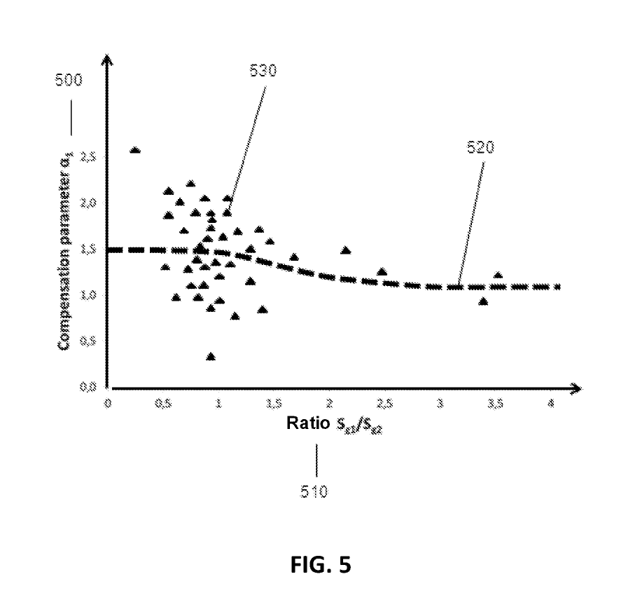

FIG. 5 presents an exemplary fit obtained by functional regression of the experimental data 530, this regression also providing a confidence interval on the estimated function.

The mean values k̅₁ and k̅₂ and the quantiles k_{M,1}, k_{m,1}, k_{M,2}, k_{m,2} corresponding to the desired confidence rate are extracted from this analysis and tabulated as a function of the ratio 510 S_{γ,1}/S_{γ,2}.

A beta signal with a minimized bias is therefore calculated in the following manner:

S_{α,β}=S_{α,β,γ,1}−k̅₁S_{γ,1}+S_{α,β,γ,2}−k̅₂S_{γ,2}

Two detection bounds are then obtained by aggregating the stochastic and systematic uncertainties deemed mutually independent:

u₊²(S_{α,β})=k²(S_{α,β,γ,1}+S_{α,β,γ,2}+k̅₁²S_{γ,1}+k̅₂²S_{γ,2})+S_{γ,1}²(k_{M,1}−k̅₁)²+S_{γ,2}²(k_{M,2}−k̅₂)²

u₋²(S_{α,β})=k²(S_{α,β,γ,1}+S_{α,β,γ,2}+k̅₁²S_{γ,1}+k̅₂²S_{γ,2})+S_{γ,1}²(k_{m,1}−k̅₁)²+S_{γ,2}²(k_{m,2}−k̅₂)²

The compensation steps according to the invention therefore become those defined hereinafter:

The parameters used are the following:

Table of mean compensation factors k₁ and k₂

Table of maximum compensation factors k_{M,1} and k_{M,2}

Table of minimum compensation factors k_{m,1} and k_{m,2}

Broadening factor k

In a first step, the reading of the counts of the two pathways (alpha, beta, gamma) and pathway (gamma) is performed:

Reading S_{α,β,γ,1} and S_{α,β,γ,2}

Reading S_{γ,1} and S_{γ,2}

In a second step, the following are calculated:

the signal S_{α,β}

ratio S_{γ,1}/S_{γ,2}

In a third step, the reading of the tables is performed:

k̅₁, k̅₂, k_{M,1}, k_{m,1}, k_{M,2}, k_{m,2}

S_{α,β}=S_{α,β,γ,1}−k̅₁S_{γ,1}+S_{α,β,γ,2}−k̅₂S_{γ,2}

Next the detection bounds are calculated.

Thereafter the reading of the tables k_{M,1}, k_{m,1}, k_{M,2}, k_{m,2} is performed.

u₊²(S_{α,β})=k²(S_{α,β,γ,1}+S_{α,β,γ,2}+k̅₁²S_{γ,1}+k̅₂²S_{γ,2})+S_{γ,1}²(k_{M,1}−k̅₁)²+S_{γ,2}²(k_{M,2}−k̅₂)²

u₋²(S_{α,β})=k²(S_{α,β,γ,1}+S_{α,β,γ,2}+k̅₁²S_{γ,1}+k̅₂²S_{γ,2})+S_{γ,1}²(k_{m,1}−k̅₁)²+S_{γ,2}²(k_{m,2}−k̅₂)²

In the following step, a detection test is performed:
if S_{α,β}>u₋²(S_{α,β}) and S_{α,β}>u₊²(S_{α,β}) then S_{α,β}=S_{α,β}
Else S_{α,β}=0

According to a development of the invention, in the case where the manufacturer cannot guarantee the reproducibility of the sensitivity of the sensors produced, a sensitivity correction parameter is added to the compensation steps according to the invention. The sensitivity of the series sensor εₛ is compared with the sensitivity of the sensor used to construct the database εₚ.

The corrective term is calculated in the following manner for each detector:

$$C = \frac{{ɛ}_{s}}{{ɛ}_{p}}$$

The compensation steps according to the invention therefore become those defined hereinafter.

The parameters used are the following:

Corrective calibration parameter C_{α,β,γ,1}, C_{α,β,γ,2}, C_{γ,1}, C_{γ,2}

Table of mean compensation factors k₁ and k₂

Table of maximum compensation factors k_{M,1} and k_{M,2}

Table of minimum compensation factors k_{m,1} and k_{m,2}

Broadening factor k

In a first step, the reading of the counts of the alpha, beta, gamma pathway 1 and of the gamma pathway 2 is performed:

Reading S_{α,β,γ,1} and S_{α,β,γ,2}

Reading S_{γ,1} and S_{γ,2}

In a second step, the corrective term is applied:

S_{α,β,γ,1}=C_{α,β,γ,1}S_{α,β,γ,1}

S_{α,β,γ,2}=C_{α,β,γ,2}S_{α,β,γ,2}

S_{γ,1}=C_{γ,1}S_{γ,1}

S_{γ,2}=C_{γ,2}S_{γ,2}

In a third step the following are calculated:

the signal S_{α,β}

the ratio S_{γ,1}/S_{γ,2}

Next, the reading of the tables is performed:

k̅₁, k̅₂, k_{M,1}, k_{m,1}, k_{M,2}, k_{m,2}

S_{α,β}=S_{α,β,γ,1}−k̅₁S_{γ,1}+S_{α,β,γ,2}−k̅₂S_{γ,2}

In the following step, the detection bounds are calculated.

Thereafter the reading of the tables is performed:

k_{M,1}, k_{m,1}, k_{M,2}, k_{m,2}

u₊²(S_{α,β})=k²(S_{α,β,γ,1}+S_{α,β,γ,2}+k̅₁²S_{γ,1}+k̅₂²S_{γ,2})+S_{γ,1}²(k_{M,1}−k̅₁)²+S_{γ,2}²(k_{M,2}−k̅₂)²

u₋²(S_{α,β})=k²(S_{α,β,γ,1}+S_{α,β,γ,2}+k̅₁²S_{γ,1}+k̅₂²S_{γ,2})+S_{γ,1}²(k_{m,1}−k̅₁)²+S_{γ,2}²(k_{m,2}−k̅₂)²

Finally the detect on test is undertaken:
if S_{α,β}>u₋²(S_{α,β}) and S_{α,β}>u₊²(S_{α,β}) then S_{α,β}=S_{α,β}
Else S_{α,β}=0

According to one embodiment, the invention comprises a single base unit. The compensation is performed with the aid of the knowledge of the database and without a priori on the anisotropy at the time of the measurement.

According to another embodiment, the invention comprises several base units (n) each comprising a pair of sensors. According to this optional implementation, a plurality of base units (amalgamating the sensors) can be deployed. The base units can be physically separated from one another. With the aid of the knowledge of the geometry existing between these base units (for example the position of robots carrying these base units may be known, optionally over time), it is possible to undertake the compensation steps such as are described. The mapping of a given zone is thereby accelerated and the measurement results are more reliable. The compensation is performed with the aid of the knowledge of the database but with a priori on the anisotropy at the time of the measurement. The case with two base units is presented in FIGS. 4 and 5. With n base units (n>2), the invention follows an approach of “inverse problem” type. When these n base units are mutually mobile, an approach of dynamic learning type makes it possible to determine the compensation parameter and its associated characteristics (geometric or systematic uncertainty, statistical uncertainty, such as standard deviation/variance, confidence threshold, statistical laws, etc.).

1. A system for compensation-based measurement of the alpha and/or beta radioactivity in a gamma background noise comprising:
a base unit comprising a first sensor allowing the measurement of the alpha and/or beta and gamma radioactivity and a second sensor not allowing the measurement of the alpha and/or beta radioactivity but allowing the measurement of the gamma radioactivity;
wherein:
the sensors are arranged so as to be exposed substantially to the same gamma background noise; measurement biases being associated with the geometric arrangement of the sensors on account of the anisotropy of the gamma radiation;
the measurement system determines the alpha and/or beta radioactivity by compensation, said compensation comprising a subtraction between the measurement of alpha and/or beta and gamma radioactivity and the gamma measurement multiplied by a compensation parameter k, said compensation minimizing the measurement biases associated with the geometric arrangement of the sensors.

2. The system as claimed in claim 1, the compensation parameter k as well as its associated properties such as its uncertainty sigma(k) being calculated on the basis of the distribution of this compensation parameter k.

3. The system as claimed in claim 2, said distribution originating from a predefined experimental database or from a base of simulated data or by accumulation of data by said measurement system.

4. The system as claimed in claim 1, a first confidence threshold being associated with the calculation of the compensation parameter k on the basis of the distribution of said compensation parameter k.

5. The system as claimed in claim 1, a second statistical confidence threshold being associated with the discrete nature of the count values arising from the pulses detected by the sensors.

6. The system as claimed in claim 4, wherein the first confidence threshold and the second confidence threshold are of the same level.

7. The system as claimed in claim 1, wherein the compensation parameter k is a mean compensation parameter k̅ or a unique and predefined compensation parameter.

8. The system as claimed in claim 1 comprising several n base units and for which the compensation takes into account the distribution of the compensation parameter as a function of the ratio of the signals of the plurality n of the base units and of the functional regression of the associated measurements in dimension n=2 or of the matrix solution of the linear system with n dimensions (if n>2).

9. The system as claimed in claim 1, wherein the sensor is a gas-type sensor and/or scintillation-type sensor and/or semiconductor-type sensor.

10. The system as claimed in claim 1, comprising the taking into account of a correction parameter for the sensitivity of a sensor.

11. The system as claimed in claim 1, further comprising an interface for display of the alpha and/or beta activity and wherein an alpha and/or beta activity is displayed only if it is deemed significant in regard to thresholds relating to statistical fluctuations of the signal arising from the sensors and/or anisotropy biases of the gamma background radiation.

12. The system as claimed in claim 8, wherein the plurality of base units is carried by aquatic, terrestrial or aerial vehicles, driven automatically or teleguided.

13. The system as claimed in claim 12, wherein the compensation parameter is calculated by an automatic learning approach.

14. The system as claimed in claim 1, wherein the radioactivity measurements and the compensation operations associated with these radioactivity measurements are decoupled in time and/or space.

15. A method of compensation-based measurement of the alpha and/or beta radioactivity in a gamma background noise comprising:
a base unit comprising a first sensor allowing the measurement of the alpha and/or beta and gamma radioactivity and a second sensor not allowing the measurement of the alpha and/or beta radioactivity but allowing the measurement of the gamma radioactivity;
wherein:
the sensors are arranged so as to be exposed substantially to the same gamma background noise; measurement biases being associated with the geometric arrangement of the sensors on account of the anisotropy of the gamma radiation;
the measurement system determines the alpha and/or beta radioactivity by compensation, said compensation comprising a subtraction between the measurement of alpha and/or beta and gamma radioactivity and the gamma measurement multiplied by a compensation parameter k, said compensation minimizing the measurement biases associated with the geometric arrangement of the sensors.

16. The measurement method as claimed in claim 15, the compensation parameter k as well as its associated properties such as its uncertainty sigma(k) being calculated on the basis of the distribution of the compensation parameter k.

17. A computer program product, said computer program comprising code instructions making it possible to perform the steps of the method as claimed in claim 15, when said program is executed on a computer.
